(19) United States
(12) Patent Application Publication
(10) Pub. No.: US 2026/0027583 A1
(43) Pub. Date: Jan. 29, 2026

(54) DEVICE COVER WITH TOPCOAT LAYER

(71) Applicant: HEWLETT- PACKARD DEVELOPMENT COMPANY, L.P., Spring, TX (US)

(72) Inventors: Chi-Chun CHIANG, Taipei City (TW); Ya-Ting YEH, Taipei City (TW); Kuan-Ting WU, Taipei City (TW); Yan-Zih CHEN, Taipei City (TW)

(73) Assignee: HEWLETT- PACKARD DEVELOPMENT COMPANY, L.P., Spring, TX (US)

(21) Appl. No.: 18/996,501

(22) PCT Filed: Jul. 19, 2022
(86) PCT No.: PCT/US2022/037577

§ 371 Date: Jan. 17, 2025

(51) Int. Cl. B05D 7/00; B05D 7/02; B05D 7/14; C09D 5/02; C09D 7/40; C09D 7/62

(52) U.S. Cl. CPC B05D 7/584; B05D 7/02; B05D 7/14; C09D 5/028; C09D 7/62; C09D 7/67; B05D 2201/02; B05D 2202/00; B05D 2401/20; B05D 2601/02

(57) ABSTRACT

An example device housing comprises a substrate, and a topcoat layer including a topcoat formulation disposed on a surface of the substrate. The topcoat formulation includes a polymer, a pigment including zirconium dioxide nanoparticles present in an amount ranging from about 0.3 weight percent to about 5 weight percent of a total weight of the topcoat formulation, and a balance of water.

### BACKGROUND

Electronic devices, such as laptop computers and mobile phones, are used by many for personal, entertainment, and business purposes. Electronic devices include electronic components which may be covered or enclosed by a device housing. Many electronic devices are portable such that they are viewed by others, and the aesthetic finish of the device housing is of increasing concern. For example, users may select the electronic devices based on the aesthetics in addition to other technical features. The device housing may provide a variety of functional features including both protecting the internal electronic components from damage and aesthetics.

### BRIEF DESCRIPTION OF THE DRAWINGS

FIG. 1 is an example of a device housing including a topcoat layer, in accordance with examples of the present disclosure.

FIGS. 2A-2D are examples of a topcoat formulation for a topcoat layer, in accordance with examples of the present disclosure.

FIG. 3 is an example electronic device including a device housing, in accordance with examples of the present disclosure.

FIG. 4 is an example device housing including a plastic substrate and a topcoat layer, in accordance with examples of the present disclosure.

FIGS. 5A-5B are example device housings including a metal substrate and a topcoat layer, in accordance with examples of the present disclosure.

FIG. 6 is an example method of forming a device housing including a topcoat layer, in accordance with examples of the present disclosure.

FIGS. 7A-7B are experimental examples of zirconium dioxide nanoparticles, in accordance with examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Device housings, sometimes referred to as device covers, may cover and protect electronic components of an electronic device, such as laptop computers, tablets, and mobile phones. For aesthetic purposes, the device housing may have a layer of paint formulation applied thereto to provide an appearance of color to the device housing. The device housing may include a substrate formed of plastic or metal, among other materials, with the paint formulation on an outer surface of the substrate. An inner surface of the substrate may be proximal to and/or other face the electronic components of the electronic device, with the outer surface being opposite the inner surface and exposed to the environment. As the outer surface of the device housing is exposed to the environment, the paint layer may be scratched, peeled, or otherwise removed, which may expose the substrate below. The substrate may be formed of material of a different color than the paint layer, and the substrate color and/or different colors may be aesthetically unpleasant to the user.

Examples of the present disclosure are directed to device housings, electronic devices including a device housing, and methods of forming a device housing that includes a topcoat layer that is resistive to scratching, peeling, or otherwise being removed. The topcoat layer includes a topcoat formulation disposed on a surface of a substrate forming the device housing. The topcoat formulation may include a polymer, a pigment including zirconium dioxide nanoparticles, and a balance of water, e.g., deionized water. The pigment including zirconium dioxide nanoparticles may be present in an amount ranging from about 0.3 weight percent (wt %) to about 5 wt % of a total weight of the topcoat formulation. The zirconium dioxide nanoparticles may enhance surface hardness of the topcoat layer on the surface of the device housing as compared to other topcoat layers. For example, the topcoat layer may have a pencil hardness of at least 3 or at least 4 and/or a Mohs hardness of at least 6. The enhanced surface hardness may reduce scratching and/or peeling of the paint from the device housing. In addition, the topcoat layer and/or topcoat formulation forming the topcoat layer may have a reduced volatile organic compounds (VOCs) emission compared to other topcoat layers, thereby providing a more environmentally friendly topcoat formulation. For example, the topcoat formulation may have a VOCs emission of less than about 500 grams/liter (g/L). In some examples, the topcoat formulation may have a VOCs emission of between about 400 g/L and about 500 g/L, or less than about 420 g/L.

As used herein, a device housing includes and/or refers to an enclosure or exterior shell for an electronic device. The device housing may include a substrate which may be formed of metal or non-metal material, such as plastic. The device housing may be formed by molding, casting, machining, bending, working, stamping, among other processes. The device housing may contain or cover the electronic components of an electronic device, and may be an integral part of the electronic device. The device cover is not meant to refer to a removable protective case, such as for smartphones and tablets, which may be purchased separately from the electronic device.

An electronic device includes and/or refers to a device with electronic components. Example electronic devices include portable electronic devices, such as laptop computers, tablets, mobile phones, game consoles, an electronic book or reader, and audio players, among non-portable electronic devices or other devices, such as a desktop computer, a keyboard, a monitor, a television screen, as well as combinations thereof. The electronic components may be enclosed by the device housing. Enclosed or encloses, as used herein, includes and/or refers to complete or partially enclosing the electronic components. For example, the device housing may include apertures or openings to access at least some electronic components, such as input/output ports (e.g., charging ports, universal serial bus ports, headphone ports), speakers and microphones, and cameras, among other components. Other electronic components may be completed enclosed by the device housing, such as motherboards, batteries, sim cards, wireless transceivers, memory storage drives, among others.

In some examples, the device housing may be formed of multiple sections or substrates, and the multiple sections may be assembled together with the electronic components to enclose the electronic device. The term “device housing” may refer to an individual section or collectively the sections assembled together with electronic components to make the complete electronic device. In other examples, the device housing may be formed of one section.

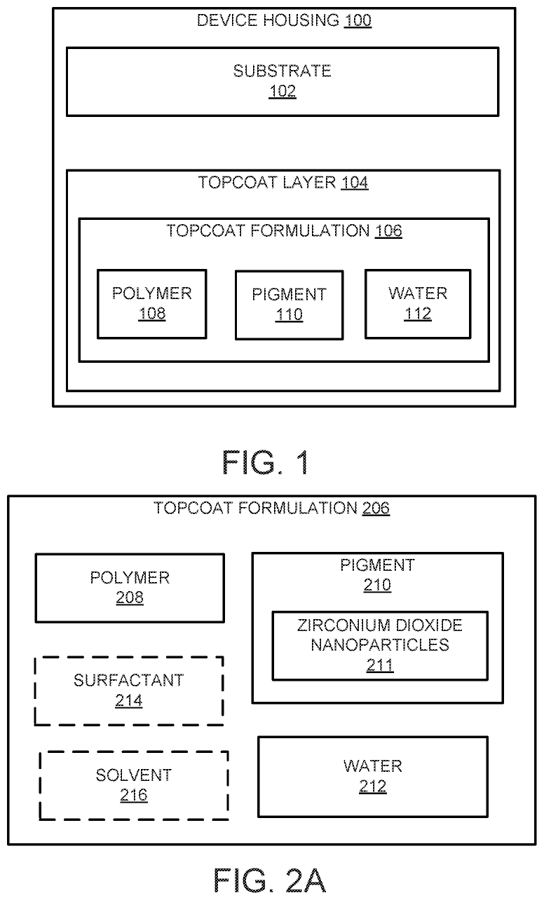

Turning now to the figures, FIG. 1 is an example of a device housing including a topcoat layer, in accordance with examples of the present disclosure. The device housing 100 may enclose electronic components of an electronic device and/or otherwise form part of the electronic device.

As shown by FIG. 1, the device housing 100 comprises a substrate 102 and a topcoat layer 104. The topcoat layer 104 is disposed on a surface of the substrate 102. As used herein, “disposed on” is not limited to being directly disposed on and may include layer(s) between the surface of the substrate 102 and the topcoat layer 104.

The substrate 102 may be formed of a metal material or a plastic material. The thickness of the substrate 102 may be selected to provide a level of strength and/or weight for the device housing 100 of the electronic device. In some examples, the substrate 102 may have a thickness from about 0.5 mm to about 2 centimeter (cm), from about 1 millimeter (mm) to about 1.5 cm, from about 1.5 mm to about 1.5 cm, from about 2 mm to about 1 cm, from about 3 mm to about 1 cm, from about 4 mm to about 1 cm, or from about 1 mm to about 5 mm, among other thicknesses and ranges. The substrate 102 may be shaped to fit any type of electronic device, and may have any thickness suitable for any type of electronic device.

Example metal materials forming the substrate 102 include aluminum, aluminum alloys, magnesium, magnesium alloys, lithium, lithium alloys, titanium, titanium alloys, stainless steel, composite metal, and various combinations thereof. Other example metal materials include niobium, zinc, bismuth, copper, cadmium, iron, thorium, strontium, zirconium, manganese, nickel, lead, silver, chromium, silicon, tin, gadolinium, yttrium, calcium, antimony, cerium, lanthanum, among others and various combinations thereof. Example plastic material forming the substrate 102 include polycarbonate (PC), acrylonitrile butadiene styrene (ABS), PC and ABS, polyphenylene sulfide (PPS), high impact polystyrene (HIPS), among others and in various combinations.

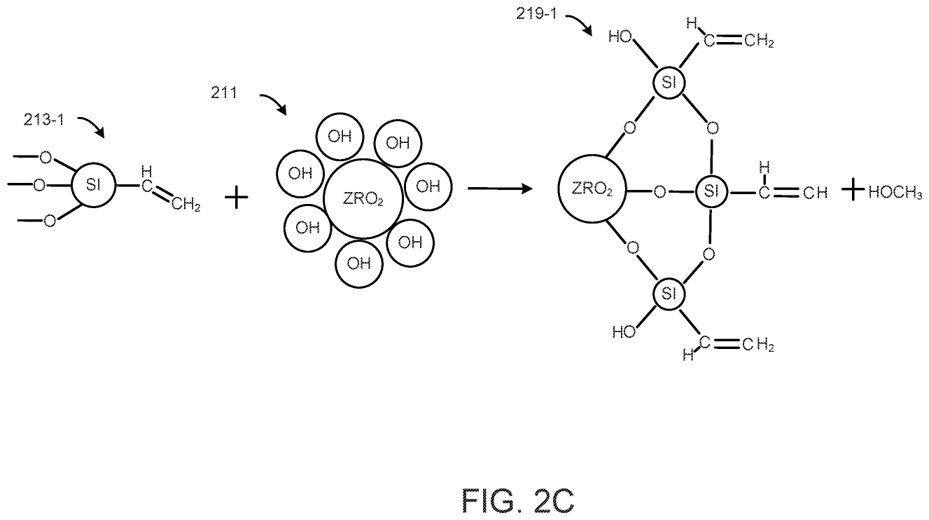

The topcoat layer 104 includes (e.g., is formed by) a topcoat formulation 106 disposed on the surface of the substrate 102. As further described and illustrated by FIG. 3, the substrate 102 may include an inner surface facing the electronic component(s) of an electronic device and an outer surface opposite the inner surface. The surface of the substrate 102 that the topcoat formulation 106 is disposed on may include outer surface which is exposed to the environment and visible to a user.

As shown by FIG. 1, the topcoat formulation 106 includes a polymer 108, a pigment 110, and a balance of water 112. The topcoat layer 104 may be applied over a primer layer on the outer surface of the substrate 102, which includes a pigment and imparts visual color to the device housing 100. The topcoat layer 104 may provide protection to the primer layer, such as preventing or mitigating scratching or peeling of the primer layer.

Example polymers in the topcoat formulation 106 include polyester, acrylic, epoxy, polyurethane, alkyd, and polyurethane copolymer, as well as combinations thereof. In some examples, the topcoat formulation 106 may include the polymer 108 present in an amount ranging from about 25 wt % to about 40 wt % of the total weight of the topcoat formulation 106. In some examples, the polymer 108 is present in an amount ranging from about 30 wt % to about 40 wt %, about 35 wt % to about 40 wt %, about 25 wt % to about 35 wt %, about 25 wt % to about 30 wt %, about 25 wt %, about 30 wt %, about 35 wt %, or about 40 wt % of the total weight of the topcoat formulation 106, among other ranges and values.

The pigment 110 includes zirconium dioxide nanoparticles present in an amount ranging from about 0.3 wt % to about 5 wt % of a total weight of the topcoat formulation 106. The zirconium dioxide nanoparticles include and/or refer to particles formed of zirconium (Zr) and two oxide (e.g., OH) compounds. In some examples, the zirconium dioxide nanoparticles are present in an amount ranging from about 0.5 wt % to about 5 wt %, about 1 wt % to about 5 wt %, about 1.5 wt % to about 5 wt %, about 2 wt % to about 5 wt %, about 2.5 wt % to about 5 wt %, about 3 wt % to about 5 wt %, about 3.5 wt % to about 5 wt %, about 4 wt % to about 5 wt %, about 4.5 wt % to about 5 wt %, about 0.3 wt % to about 4.5 wt %, about 0.3 wt % to about 4 wt %, about 0.3 wt % to about 3.5 wt %, about 0.3 wt % to about 3 wt %, about 0.3 wt % to about 2.5 wt %, about 0.3 wt % to about 2 wt %, about 0.3 wt % to about 1.5 wt %, about 0.3 wt % to about 1 wt %, about 1 wt % to about 2 wt %, about 1 wt % to about 3 wt %, about 1 wt % to about 4 wt %, about 1.5 wt % to about 3 wt %, about 1.5 wt % to about 4 wt %, about 2 wt % to about 4 wt %, about 2 wt % to about 3 wt %, or about 2 wt % to about 4 wt % of the total weight of the topcoat formulation 106, among other values and ranges.

The zirconium dioxide nanoparticles in the topcoat formulation 106 may provide hardness to the topcoat layer 104. For example, the topcoat layer 104 have pencil hardness (H) of at least 3 or at least 4, or more, such as up to about 6. In some examples, the topcoat layer 104 may have a Mohs hardness of at least 6. In some examples, the topcoat layer 104 has a Mohs hardness ranging from about 5 to at least 10, of at least 6, at least 7, at least 8, at least 9, at least 10, or more, among other values and ranges. Further, the topcoat formulation 106 may be environmentally friendly. For example, the topcoat formulation 106 may be associated with a VOCs emission of less than about 500 g/L, such as between about 400 g/L and about 500 g/L or less than about 420 g/L.

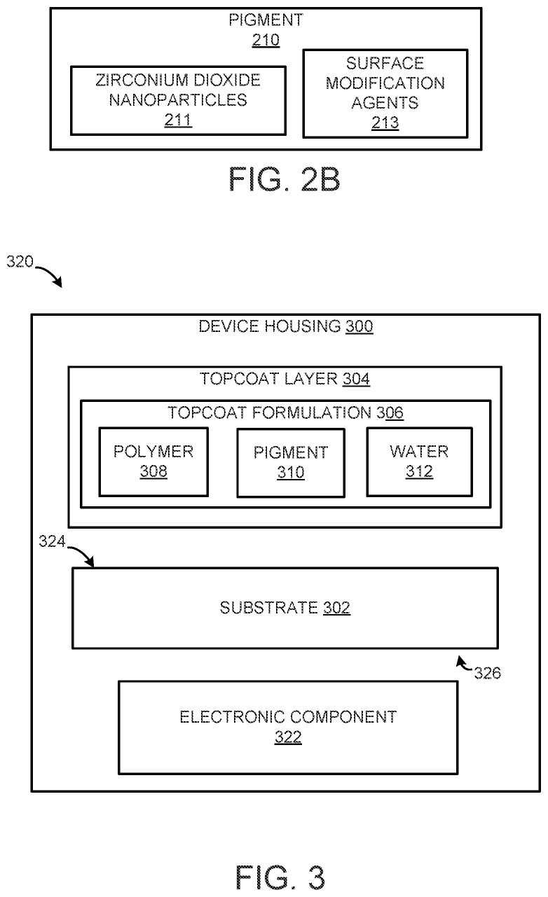

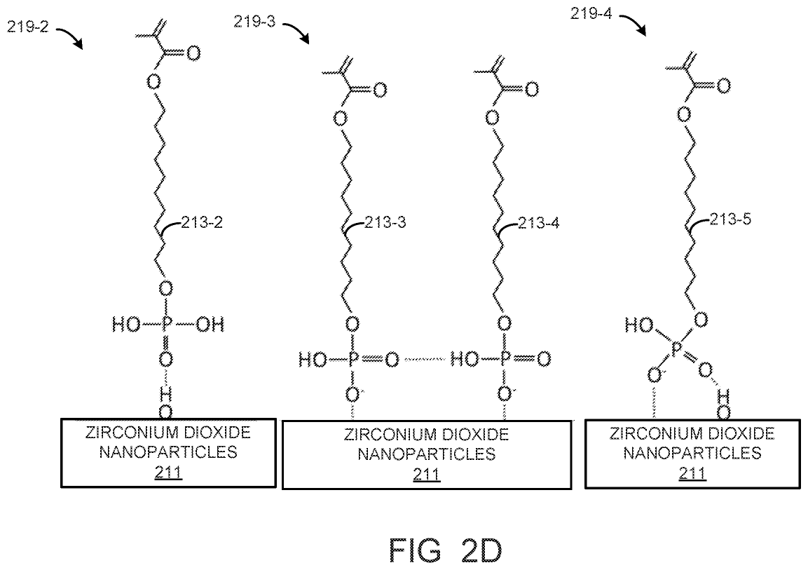

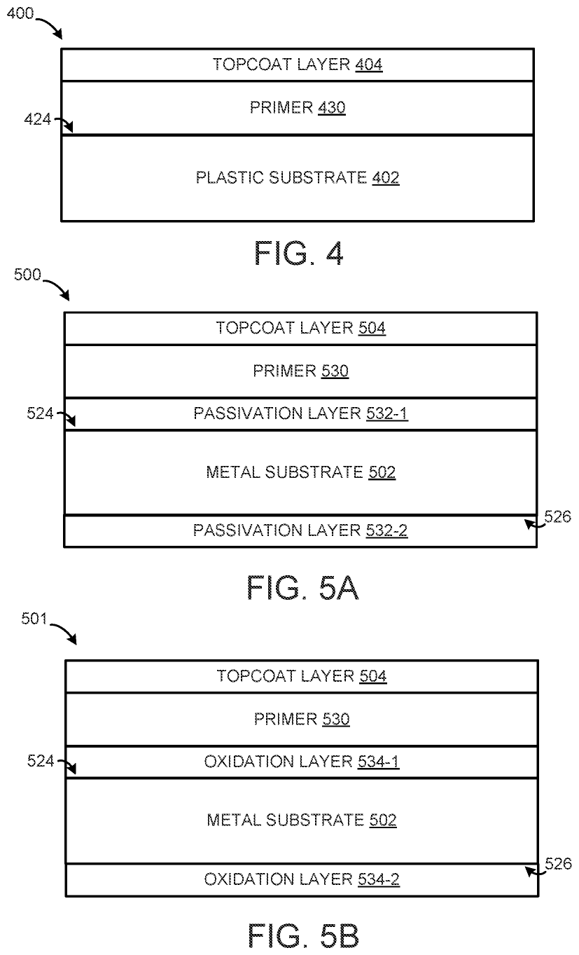

The topcoat formulation 106 may include variations from that illustrated by FIG. 1, such as including additional components. Example variations includes a surface modification agent, surfactants, and solvents. FIGS. 2A-2B illustrates example variations to the topcoat formulation 106. In some examples, the device housing 100 may include variations from that illustrated by FIG. 1, such as additional layers on the device housing 100. FIGS. 4A-5 illustrates example various to the device housing.

FIGS. 2A-2D are examples of a topcoat formulation for a topcoat layer, in accordance with examples of the present disclosure.

The topcoat formulation 206 of FIG. 2A may include an example implementation of and/or include at least some of substantially the same features as the topcoat formulation 106 illustrated by FIG. 1, the common features not being fully repeated for ease of reference but which may include the examples previously described. For example, similar to FIG. 1, the topcoat formulation 206 of FIG. 2A includes a polymer 208, the pigment 210 including the zirconium dioxide nanoparticles 211, and water 212.

The zirconium dioxide nanoparticles 211 may include or be powder particles having diameters ranging from about 5 nanometers (nm) to about 100 nm. In some examples, the zirconium dioxide nanoparticles 211 may include or be powder particles having diameters ranging from about 20 nm to about 50 nm. For example, the pigment 210 may be made of up of similarly sized or different sized zirconium dioxide nanoparticles 211 within the diameter range. Size, as used herein, refers to the diameter of a spherical particle, or the average diameter of a non-spherical particle. In some examples, the zirconium dioxide nanoparticles 211 may be tetrahedral shaped. In some examples, the zirconium dioxide nanoparticles 211 may be round shaped. In some examples, the diameter or average diameter of the zirconium dioxide nanoparticles 211 may be measured using an analytical chemical analysis. For example, the average diameter of the zirconium dioxide nanoparticles 211 may be measured using a volume based size distribution. The size of the zirconium dioxide nanoparticles 211 may be measured by using a static light scattering technique, such as laser diffraction. In some examples, the zirconium dioxide nanoparticles 211 may be refractive and have a Mohs hardness of at least 6.

In some examples, as illustrated by FIG. 2B, the pigment 210 further includes a surface modification agent 213 bound to the zirconium dioxide nanoparticles 211. That is, the zirconium dioxide nanoparticles 211 may be surface modified. Example surface modification agents 213 include vinyltrimethoxysilane, 10-methacryloyloxy-decyl-dihydrogen-phosphate (10-MDP), 3-methacryloxypropyltrimethoxysilane, vinyltriisopropoxysilane, methyltriethoxysilane (MTES) and tetraethoxysilane (TEOS), methyltrichlorosilane, methyltrimethoxysilane, and methyltriethoxysilane. In some examples, the surface modification agent 213 includes vinyltrimethoxysilane, as shown by FIG. 2C, or 10-MDP, as shown by FIG. 2D. The surface modification agents 213 may bind to the zirconium dioxide nanoparticles 211 via hydrogen bonding and/or chemical bonding.

Modifying the zirconium dioxide nanoparticles 211 with the surface modification agent 213 may improve jettability or flowability of the topcoat formulation as compared to unmodified zirconium dioxide nanoparticles 211. For example, the zirconium dioxide nanoparticles 211 without modification may settle with high density or may agglomerate together and not spread out. The surface modification agent 213 may increase distribution and dispersion, as well as mitigating or avoiding sedimentation or agglomeration, of the zirconium dioxide nanoparticles 211 in the topcoat layer.

Referring back to FIG. 2A, in some examples, the topcoat formulation 206 may include additional components, such as a surfactant 214 and/or a solvent 216. The surfactant 214 may improve jettability of the topcoat formulation 206 and/or allow for the topcoat formulation 206 to spread uniformly into a topcoat layer when applied. The solvent 216 may be used to dissolve the components and/or disperse the zirconium dioxide nanoparticles 211 into solution, for example.

Example surfactants include alcohol sulfates, alkylbenzene sulfonates, sodium caseinate, sodium polyacrylate, sodium polyoxyethylene alkyl ether carboxylate, and sodium dodecyl sulfate, as well as combinations thereof. The surfactant 214 may be present in an amount ranging from about 0.3 wt % to about 2 wt % of the total weight of the topcoat formulation 206. In some examples, the surfactant 214 is present in an amount ranging from about 0.5 wt % to about 2 wt %, about 1 wt % to about 2 wt %, about 1.5 wt % to about 2 wt %, about 0.3 wt % to about 1.5 wt %, about 0.3 wt % to about 1 wt %, about 0.3 wt % to about 0.5 wt %, about 0.5 wt % to about 1.5 wt %, or about 1 wt % to about 1.5 wt % of the total weight of the topcoat formulation 206, among other ranges and values.

Example solvents include methyl ethyl ketone, methyl isobutyl ketone, 3-methoxy-3-methyl-1-butyl acetate, ethyl acetate, and butyl acetate. The solvent 216 may be present in an amount ranging from about 15 wt % to about 25 wt % of the total weight of the topcoat formulation 206. In some examples, the solvent 216 is present in an amount ranging from about 15 wt % to about 20 wt %, about 18 wt % to about 20 wt %, about 20 wt % to about 25 wt %, about 22 wt % to about 25 wt %, about 15 wt %, about 20 wt %, or about 25 wt % of the total weight of the topcoat formulation 206, among other ranges and values.

In some examples, the topcoat formulation 206 includes: (i) about 25 wt % to about 40 wt % polymer 208; (ii) about 0.3 wt % to about 5 wt % pigment 210 containing zirconium dioxide nanoparticles 211; (iii) about 0.3 wt % to about 2 wt % surfactant 214; (iv) about 15 wt % to about 25 w % solvent 216; and (v) a balance of water 212 (e.g., de-ionized water). The wt % provided above include amounts of the total weight of the topcoat formulation 206.

FIGS. 2C-2D illustrate example surface modified zirconium dioxide nanoparticles 219-1, 219-2, 219-3, 219-4. More specifically, FIG. 2C illustrates a surface modified zirconium dioxide nanoparticle 219-1 that is formed by surface modifying or reacting a zirconium dioxide nanoparticle 211 with a surface modification agent 213-1 that includes vinyltrimethoxysilane. FIG. 2D illustrates surface modified zirconium dioxide nanoparticles 219-2, 219-3, 219-4 that are formed by surface modifying or reacting zirconium dioxide nanoparticles 211 with surface modification agents 213-2, 213-3, 213-4, 213-5 that includes 10-MDP.

FIG. 3 is an example electronic device including a device housing, in accordance with examples of the present disclosure. The device housing 300 and topcoat formulation 306 of FIG. 3 may include an example implementation of and/or include at some of substantially the same features as the device housing 100 and topcoat formulations 106, 206 illustrated by FIG. 1 and FIGS. 2A-2B, the common features not being fully repeated for ease of reference but which may include the examples previously described.

The electronic device 320 includes an electronic component 322 and a device housing 300 to house the electronic component 322. Although FIG. 3 illustrates a single electronic component 322, the electronic device 320 may include a set of electronic components which are enclosed by the device housing 100.

The device housing 300 includes a substrate 302 including an inner surface 326 facing the electronic component 322 and an outer surface 324 opposite the inner surface 326. As previously described, the outer surface 324 may be visible to the user and may be exposed to the environment. The inner surface 326, in contrast, may not be visible to the user and/or not easily visible.

Similar to FIG. 1, the device housing 300 further includes a topcoat layer 304 including a topcoat formulation 306 disposed on the outer surface 324 of the substrate 302. The topcoat formulation 306 includes a polymer 308, the pigment 310 including the zirconium dioxide nanoparticles, and water 312. As previously described, the pigment 310 may be present in an amount ranging from about 0.3 wt % to about 5 wt % of a total weight of the topcoat formulation 306. The topcoat formulation 306 may include additional components, such as a surfactant and/or solvent as illustrated by FIG. 2A.

The device housing 300 and/or topcoat formulation 306 may include variations, such as those illustrated by FIGS. 2A-2B and/or FIGS. 4-5B. In some examples, the topcoat formulation 306 may include additional components, such as a surfactant and/or solvent as illustrated by FIG. 2A. In some examples, the zirconium dioxide nanoparticles of the pigment 310 are surface modified to increase distribution and dispersion, and to avoid sedimentation (e.g., mitigate agglomeration) of the zirconium dioxide nanoparticles in the topcoat layer 304, such as via a surface modification agent as illustrated by FIG. 2B.

In some examples, the device housing 300 includes additional layers. For example, the device housing 300 may further include a primer layer between the outer surface 324 of the substrate 302 and the topcoat layer 304. The primer layer may include or be formed from a primer formulation that includes a second polymer and a second pigment. The second polymer may include epoxy, epoxy-polyester, polyester, polyurethane, or a polyurethane copolymer, and combinations thereof. In some examples, the second polymer may be present in an amount ranging from about 20 wt % to about 45 wt % of a total weight of the primer formulation. The second pigment may provide an appearance of color to the device housing 300. Example pigments include talc, carbon black, titanium dioxide, clay, mica, barium sulfate, calcium carbonate, or another color pigments and combinations thereof. In some examples, the pigment may be present in an amount ranging from about 2 wt % to about 15 wt % of a total weight of the primer formulation. The primer formulation may include other components, such as surfactants, solvents, and an additive such as a buffer and/or a biocide. The balance of the primer formulation may include water.

In some examples, the substrate 302 may be formed of a plastic material and the device housing 300 may further include the primer layer between the outer surface 324 of the substrate 302 and the topcoat layer 304, the primer layer including the primer formulation that includes a second polymer and a second pigment.

In other examples, the substrate 302 may be formed of a metal material. In such examples, the device housing 300 may further include treatment layers disposed on the outer surface 324 (e.g., between the outer surface 324 and a primer layer) and the inner surface 326 of the metal substrate. The treatment layers may include passivation layers or oxidation layers, as further described herein. The passivation layers or oxidation layers may be disposed on the outer surface 324 or both the outer surface 324 and the inner surface 326 of the substrate. The treatment layers may help in providing resistance against corrosion and wear to a metal substrate. The treatment layers may further help in providing electrical insulation and durability to the metal substrate.

FIG. 4 is an example device housing including a plastic substrate and a topcoat layer, in accordance with examples of the present disclosure. The device housing 400 illustrated by FIG. 4 includes a plastic substrate 402, a topcoat layer 404, and a primer layer 430 disposed between the outer surface 424 of the plastic substrate 402 and the topcoat layer 404, as previously described. The details of which are not repeated for ease of reference.

The primer layer 430 may be formed by applying a primer formulation to the outer surface 424 of the plastic substrate 402. The primer formulation may include a second polymer and a second pigment. As previously described, the second polymer may include epoxy, epoxy-polyester, polyester, polyurethane, or a polyurethane copolymer, and combinations thereof, and that is present in an amount ranging from about 20 wt % to about 45 wt % of a total weight of the primer formulation. The second pigment may include talc, carbon black, titanium dioxide, clay, mica, barium sulfate, calcium carbonate, or another color pigments and combinations thereof, and that is present in an amount ranging from about 2 wt % to about 15 wt % of a total weight of the primer formulation. In some examples, the applied primer formulation may be cured by baking the surface 424 at a temperature ranging from about 80 degrees Celsius (C) to about 140 degrees C. for a time period ranging from about 15 minutes to about 40 minutes.

The topcoat layer 404 may be formed by applying a topcoat formulation to the primer layer 430. The topcoat formulation may include any of the previously described formulations. In some examples, the applied topcoat formulation may be cured by baking the surface 424 at a temperature ranging from about 80 degrees C. to about 140 degrees C. for a time period ranging from about 15 minutes to about 40 minutes.

In some examples, the primer layer 430 is between about 10 μm and about 18 μm in thickness and the topcoat layer 404 is between about 6 μm and about 15 μm in thickness. However examples are not so limited and the different layers may have a variety of thickness. The thickness of the various layers, such as the primer layers, topcoat layers, and/or treatment layers, may be measured after forming the layers, for example, using a micrometer screw gauge or scanning electron microscope (SEM).

FIGS. 5A-5B are example device housings including a metal substrate and a topcoat layer, in accordance with examples of the present disclosure. Each of the device housings 500, 501 illustrated by FIGS. 5A-5B include a metal substrate 502, a topcoat layer 504, and a primer layer 530 disposed between the outer surface 524 of the metal substrate 502 and the topcoat layer 504, as previously described. The details of which are not repeated.

In some examples, the metal material used for the metal substrate 502 may be a light metal. The term “light metal” includes and/or refers to metals and alloys that are of relatively low density including metal that is less than about 5 g/cm³ in density. In some examples, a light metal may be a material including aluminum, magnesium, titanium, lithium, zinc, and alloys and/or combinations thereof. These light metals may have useful properties, such as low weight, high strength, and an appealing appearance. The metal material, such as aluminum or magnesium, may have a porous surface that is vulnerable to chemical reactions or corrosion at the surface. As further described herein, the metal substrate may be treated to form treatment layers on the outer and inner surfaces of the substrate, such as a passivation layer or oxidation layer.

FIG. 5A illustrates an example device housing 500 that includes a metal substrate 502 and first and second passivation layers 532-1, 532-2. For example, a first passivation layer 532-1 is disposed on the outer surface 524 of the metal substrate 502, and a second passivation layer 532-2 is disposed on an inner surface 526 of the metal substrate 502. A primer layer 530 is disposed between the first passivation layer 532-1 and the topcoat layer 504.

The first and second passivation layers 532-1, 532-2 may include or be formed from a passivation formulation including a passivation agent selected from the group consisting of molybdates, vanadates, phosphates, chromates, stannates and manganese salt. A passivation agent includes and/or refers to a chemical that reacts with a surface of the substrate to turn, at least a portion of the substrate, non-metallic. To form the passivation layers 532-1, 532-2, the inner and outer surfaces 524, 526 of the metal substrate 502 may be chemically treated with or using the passivation agent such that the surfaces 524, 526 react with the passivation agent and turn into a non-metallic surface, such as a salt film. In some examples, the metal substrate 502 may be chemically treated for a time period in a range of about 0.5 minutes to about 3 minutes and at a temperature range of about 25 degrees C. to about 40 degrees C. to obtain the passivation layers 532-1, 532-2. In some examples, the passivation formulation may include the passivation agent present in an amount ranging from about 3 wt % to about 15 wt % of the total weight of the passivation formulation, and a balance of water.

In some examples, primer layer 530 is between about 10 μm and about 18 μm in thickness, the topcoat layer 504 is between about 6 μm and about 15 μm in thickness, and the first and second passivation layers 532-1, 532-2 are between about 1 μm and about 5 μm in thickness. However examples are not so limited and the different layers may have a variety of thickness.

A passivation layer may include and/or refer to a layer or coating over the metal substrate 502. Passivation may refer to the use of a coat of a protective material, such as metal oxide, to create a shell against corrosion. The passivation agent, e.g., a chemical, may be applied to the surface of the metal substrate 502 to induce the passivation layers 532-1, 532-2. The passivation layers 532-1, 532-2 may be transparent. It is noted that the passivation layers are described as a layer for convenience, and may be in the form of a layer. However, the term “passivation layer” also includes metal surface treatment of the exposed metal substrate 502.

In some examples, the passivation layers 532-1, 532-2 may include a chelating agent and a metal ion or a chelated metal complex thereof, wherein the metal ion is an aluminum ion, an indium ion, a nickel ion, a chromium km, a tin ion, or a zinc ion. In some examples, passivation treatment may be applied at a pH ranging from about 2 to about 6. In some examples, the pH may be ranging from about 2.5 to about 3.5. In further examples, the passivation layers 532-1, 532-2 may include an oxide of one of these metals. In some examples, various contaminants may be present on the surface of the metal substrate 502. A chelating agent may be used to chelate such contaminants and prevent the contaminants from attaching to the surface of the metal substrate 502. Non-limiting examples of chelating agents may include ethylenediaminetetraacetic acid, ethylenediamine, nitrilotriacetic acid, diethyienetriaminepenta (methylenephosphonic acid), nitrilotris (methyienephosphonic acid), and 1-hydroxyethane-1,1-disphosphonic acid. At the same time, a passivating layer may form on the surface of the metal substrate 502. In some examples, the passivation layers 532-1, 532-2 may be added to the pre-existing surface of the metal substrate 502, such that the passivation layers 532-1, 532-2 include additional material added onto the surface of the metal substrate 502. In other examples, the passivation layers 532-1, 532-2 may involve converting the existing surface of the metal substrate 502 into a passivation layer so that no net addition of material to the pre-existing surface occurs.

The passivation layers 532-1, 532-2 may be applied via any the above-described passivation treatments which may be applied for a time period ranging from about 0.5 minutes to about 3 minutes. The primer layer 530 may be formed by applying a primer formulation to the first passivation layer 532-1. The primer formulation may include any of the previously described formulations. The applied primer formulation may be cured by baking the surface at a temperature ranging from about 80 degrees C. to about 140 degrees C. for a time period ranging from about 15 minutes to about 40 minutes. And, the topcoat layer 504 may be formed by applying a topcoat formulation to the primer layer 530. The topcoat formulation may include any of the previously described formulations. The applied topcoat formulation may be cured by baking the surface at a temperature ranging from about 80 degrees C. to about 140 degrees C. for a time period ranging from about 15 minutes to about 40 minutes.

FIG. 5B illustrates an example device housing 501 that includes a metal substrate 502 and first and second oxidation layers 534-1, 534-2. For example, a first oxidization layer 534-1 is disposed on the outer surface 524 of the metal substrate 502, and a second oxidization layer 534-2 is disposed on an inner surface 526 of the metal substrate 502, wherein the first and second oxidization layers 534-1, 534-2 include an oxide film. A primer layer 530 is disposed between the first oxidization layer 534-1 and the topcoat layer 504.

In some examples, primer layer 530 is between about 10 μm and about 18 μm in thickness, the topcoat layer 504 is between about 6 μm and about 15 μm in thickness, and the first and second oxidation layers 534-1, 534-2 are between about 2 μm and about 7 μm in thickness. However examples are not so limited and the different layers may have a variety of thickness.

The oxidation layers 534-1, 534-2 may be applied onto the metal substrate 502 via a micro-arc oxidation (MAO) treatment. MAO, also known as plasma electrolytic oxidation, is an electrochemical process where the surface of the metal substrate 502 is oxidized using micro-discharges of compounds on the surface of the metal substrate 502 when immersed in a chemical or electrolytic bath in an electrolytic solution, such as an alkaline electrolyte for example. The electrolytic solution may include predominantly water with about 1 wt % to about 5 wt % oxidation agent(s), e.g., alkali metal silicates, alkali metal hydroxide, alkali metal fluorides, alkali metal phosphates, alkali metal aluminates, the like, or a combination thereof. The oxidation agents includes and/or refers to an electrolytic compound, which when dissolved, may break up into cations and ions. Example electrolyte solutions include an alkaline solution having electrolytes selected from the group consisting of sodium silicate, sodium phosphate, potassium fluoride, potassium hydroxide, sodium hydroxide, fluorozirconate, sodium hexametaphosphate, sodium fluoride, aluminum oxide, silicon dioxide, ferric ammonium oxalate, phosphoric acid salt, polyethylene oxide alkylphenolic ether, and combinations thereof. The oxidation agents may be included in an amount ranging from about 1.5 wt % to about 3.5 wt %, or from about 2 wt % to about 3 wt % of a total weight of the electrolyte solution, although examples are not so limited.

In some examples, the electrolyte solution may be kept inside an electrolytic bath and maintained at a temperature in a range of about 10 degrees C. to about 45 degrees C. In some examples, the electrolyte solution may be kept inside an electrolytic bath and maintained at a temperature in a range of about 15 degrees C. to about 40 degrees C., about 20 degrees C. to about 40 degrees C., or about 25 degrees C. to about 35 degrees C., among other temperatures. The surfaces 524, 526 of the metal substrate 502 are then immersed in the electrolyte solution inside the electrolytic bath. In some examples, a current or voltage may be applied to the metal substrate 502 to create plasma on the surface of the metal substrate 502. In this process, the metal substrate 502 may act as one electrode immersed in the electrolyte solution, and a counter electrode may be any other electrode that is also in contact with the electrolyte. In some examples, the counter electrode may be an inert metal, such as stainless steel. In some examples, the bath holding the electrolyte solution is conductive and the bath itself may be used as the counter electrode.

In some examples, a high direct current or alternating voltage may be applied to the metal substrate 502 and the counter electrode. In some examples, the voltage may about 200 volts (V) or higher, such as about 200 V to about 600 V, about 250 V to about 600 V, about 250 V to about 500 V, or about 200 V to about 300 V, and while the bath is at the above-described temperature range. This process may oxidize the surfaces 524, 526 to form an oxidation layer from the substrate material. Various metal or metal alloy substrates may be used, including aluminum, titanium, lithium, magnesium, and/or alloys thereof, for example. The oxidation may extend below the surfaces 524, 526 to form the oxidation layers 534-1, 534-2.

The thickness of the oxidation layers 534-1, 534-2 may depend on the time period for which the electrolysis is performed. In some examples, the oxidation layers 534-1, 534-2 may have a thickness from about 2 μm to about 7 μm. The oxidation layers 534-1, 534-2 may enhance the mechanical, wear, thermal, dielectric, and/or corrosion properties of the metal substrate 502. The electrolyte solution may include a variety of electrolytes, such as a solution of potassium hydroxide.

The oxidation layers 534-1, 534-2 may be formed via any the above-described MAO treatments. The primer layer 530 may be formed by applying a primer formulation to the first oxidation layer 534-1. The primer formulation may include any of the previously described formulations. The applied primer formulation may be cured by baking the surface at a temperature that may range from about 80 degrees C. to about 140 degrees C. for a time period that may range from about 15 minutes to about 40 minutes. And, the topcoat layer 504 may be formed by applying a topcoat formulation to the primer layer 530. The topcoat formulation may include any of the previously described formulations. The applied topcoat formulation may be cured by baking the surface at a temperature that may range from about 80 degrees C. to about 140 degrees C. for a time period that may range from about 15 minutes to about 40 minutes.

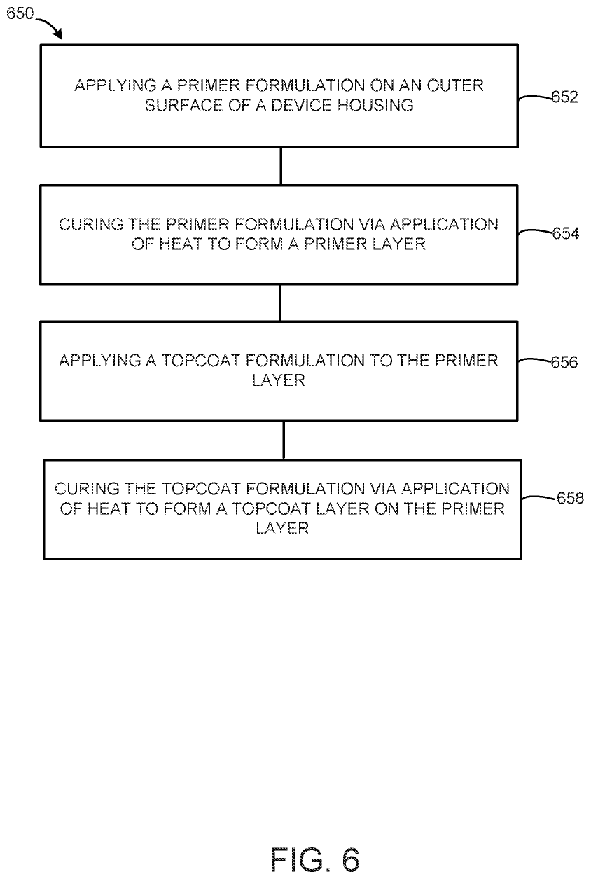

FIG. 6 is an example method of forming a device housing including a topcoat layer, in accordance with examples of the present disclosure. The method 650 may be implemented to form any of the previously described device housings and/or topcoat layers.

At 652, the method 650 includes applying a primer formulation on an outer surface of a substrate of a device housing. At 654, the method includes curing the primer formulation via application of heat to form a primer layer. At 656, the method 650 includes applying a topcoat formulation to the primer layer, the topcoat formulation including a polymer, a pigment including zirconium dioxide nanoparticles, the pigment being present in an amount ranging from about 0.3 wt % to about 5 wt % of a total weight of the topcoat formulation, and a balance of water. And, at 658, the method 650 includes curing the topcoat formulation via application of heat to form a topcoat layer on the primer layer. For example, curing the primer formulation and the topcoat formulation may each include applying heat (to the substrate) at a temperature ranging from about 80 degrees C. to about 140 degrees C. for a time period ranging from about 15 minutes to about 40 minutes.

The topcoat formulation and/or primer formulation may be paint compositions which may be printed, jetted, and/or sprayed onto the device housing. In some examples, applying the topcoat formulation to the primer layer includes digitally printing the topcoat formulation. In some examples, the primer formulation is further digitally printed. In some examples, the layers may be formed by spray coating or electrostatically-applied coating a formulation to a surface of the substrate. The primer and topcoat layers may provide an aesthetic appeal and/or protection to the housing.

In various examples, the method 650 further includes treating the outer surface and an inner surface of the device housing that is opposite the outer surface with a passivation agent or an oxidization agent, prior to applying the primer formulation, to form treatment layers. For example, the method 650 may include treating the outer and inner surfaces with the passivation agent or oxidation agent to form a first passivation or oxidization layer disposed on the outer surface of the substrate, such that the first passivation or oxidization layer is disposed between the primer layer and the outer surface of the substrate, and/or a second passivation or oxidization layer is disposed on the inner surface of the substrate.

In some examples, the device housing described herein may made by first forming the substrate. This may be accomplished using a variety of processes, including molding, insert molding, forging, casting, machining, stamping, bending, working, and so on. The substrate may be made from a variety of metals, plastics, and/or other materials. In one example, sheet or forged metal is insert molded into the shape of a cover. The metal for the substrate may be aluminum, magnesium, lithium, titanium, and alloys thereof. As mentioned above, in some examples, the substrate may be a single piece, while in other examples, the substrate may include multiple pieces that each make up a portion of the cover. Additionally, in some examples, the substrate may be a composite made up of multiple metals and/or plastics combined, such as having layers of multiple different metals, plastics, and/or other materials, or panels or other portions of the substrate being different materials.

Various examples may be directed to method of forming the topcoat formulation. The method may include mixing the pigment including the zirconium dioxide nanoparticles with the polymer, a solvent, a surfactant, and water. The mixing may be provided by a variety of sources, such as a mixer. Example mixers include an industrial paddle mixer, a high shear mixer, a resonant acoustic mixer, and a jet mills, among others. In some examples, a mixer mill may be used such as a ball mill or power mill.

The above-described topcoat formulations are used to form topcoat layers on metal or plastic device housings to obtain pencil hardness of at least 3 H or 4 H via the use of zirconium dioxide nanoparticles, and which may be in powder form. The zirconium dioxide nanoparticles may be used to mitigate or reduce scratching and/or peeling off of the primer layer by provided enhanced surface abrasion resistance and hardness. The zirconium dioxide nanoparticles may be tetrahedral and/or round in shape and may establish chemical bonding with resin and exhibit stabilized dispersion in the topcoat formulation. The topcoat formulation and/or primer formulation may be paint compositions which may be printed, jetted, and/or sprayed onto the device housing.

The various ranges provided herein include the stated range and any value or sub-range within the stated range. Furthermore, when “about” is utilized to describe a value, this includes, refers to, and/or encompasses variations (up to +/−10%) from the stated value. Wt %, as used herein, includes or refers to a weight of a component as a percent of the total weight of the composition or solution.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of color pigments, the term “pigment” may be used more generally to describe color pigments and other pigments such as organometallics, ferrites, ceramics, etc. In one specific example, however, the pigment is a color pigment or colorant.

Reference throughout the specification to “examples”, “an example”, “some examples”, and so forth, means that a particular element (e.g., feature, structure, and/or characteristic) described in connection with the example is included in the example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

### EXAMPLES

The following illustrates example topcoat formulations including zirconium dioxide nanoparticles, and related aspects described herein. These examples should not be considered to restrict the present disclosure, but are merely in place to teach how to make examples of topcoat formulations. Various experiments were directed to generating topcoat formulations.

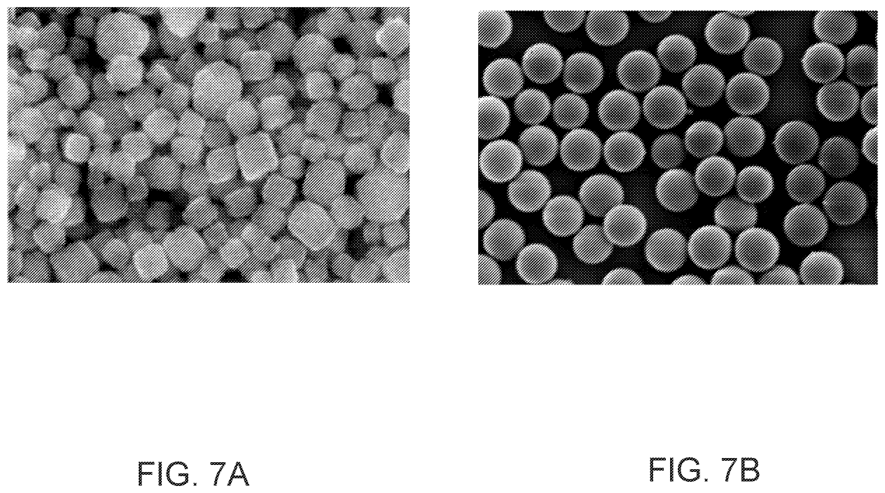

FIGS. 7A-7B are experimental examples of zirconium dioxide nanoparticles, in accordance with examples of the present disclosure. More particularly, the images are of a topcoat layer that includes the zirconium dioxide nanoparticles. The zirconium dioxide nanoparticles were tetrahedral in shape, as shown by FIG. 7A, or round in shape, as shown by FIG. 7B. Further, the zirconium dioxide nanoparticles range in diameter from about 5 nm to 100 nm, and achieved a Mohs hardness of at least 6.

1. A device housing, comprising:
a substrate; and
a topcoat layer including a topcoat formulation disposed on a surface of the substrate, the topcoat formulation including:
a polymer;
a pigment including zirconium dioxide nanoparticles present in an amount ranging from about 0.3 weight percent (wt %) to about 5 wt % of a total weight of the topcoat formulation; and
a balance of water.

2. The device housing of claim 1, wherein the polymer is present in an amount ranging from about 25 wt % to about 40 wt % of the total weight of the topcoat formulation, and the topcoat layer has a pencil hardness (H) of at least 3.

3. The device housing of claim 1, wherein the zirconium dioxide nanoparticles are powder particles having diameters ranging from about 5 to about 100 nanometers (nm).

4. The device housing of claim 1, wherein the topcoat formulation is associated with a volatile organic compounds (VOCs) emission of less than about 500 grams/liter.

5. The device housing of claim 1, wherein the pigment further includes a surface modification agent bound to the zirconium dioxide nanoparticles.

6. The device housing of claim 5, wherein the surface modification agent includes vinvyltrimethoxysilane or 10-methacryloyloxy-decyl-dihydrogen-phosphate (10-MDP).

7. The device housing of claim 5, wherein the surface modification agent is selected from the group consisting of:
vinyltrimethoxysilane, 10-methacryloyloxy-decyl-dihydrogen-phosphate (10-MDP), 3-methacryloxypropyltrimethoxysilane, vinyltriisopropoxysilane, methyltriethoxysilane (MTES) and tetraethoxysilane (TEOS), methyltrichlorosilane, methyltrimethoxysilane, and methyltriethoxysilane.

8. An electronic device, comprising:
an electronic component; and
a device housing to house the electronic component, the device housing including:
a substrate including an inner surface facing the electronic component and an outer surface opposite the inner surface;
a topcoat layer including a topcoat formulation disposed on the outer surface of the substrate, the topcoat formulation including:
a polymer; and
a pigment including zirconium dioxide nanoparticles, the pigment present in an amount ranging from about 0.3 weight percent (wt %) to about 5 wt % of a total weight of the topcoat formulation; and
a balance of water.

9. The device of claim 8, wherein the zirconium dioxide nanoparticles are surface modified to increase distribution and dispersion of the zirconium dioxide nanoparticles in the topcoat layer.

10. The device of claim 8, wherein the substrate includes a plastic material, and the device housing further includes:
a primer layer between the outer surface of the substrate and the topcoat layer, the primer layer including a primer formulation that includes a second polymer and a second pigment.

11. The device of claim 8, wherein the substrate includes a metal material, and the device housing further includes:
a first passivation layer disposed on the outer surface of the substrate;
a second passivation layer disposed on an inner surface of the substrate, wherein the first and second passivation layers include a passivation formulation including a passivation agent selected from the group consisting of:
molybdates, vanadates, phosphates, chromates, stannates, and manganese salts; and
a primer layer disposed between the first passivation layer and the topcoat layer.

12. The device of claim 8, wherein the substrate includes a metal material, and the device housing further includes:
a first oxidization layer disposed on the outer surface of the substrate;
a second oxidization layer disposed on an inner surface of the substrate, wherein the first and second oxidization layers include an oxide film; and
a primer layer disposed between the first oxidization layer and the topcoat layer.

13. A method, comprising:
applying a primer formulation on an outer surface of a substrate of a device housing;
curing the primer formulation via application of heat to form a primer layer;
applying a topcoat formulation to the primer layer, the topcoat formulation including:
a polymer;
a pigment including zirconium dioxide nanoparticles, the pigment being present in an amount ranging from about 0.3 weight percent (wt %) to about 5 wt % of a total weight of the topcoat formulation; and
a balance of water; and
curing the topcoat formulation via application of heat to form a topcoat layer on the primer layer.

14. The method of claim 13, wherein the curing the primer formulation and the topcoat formulation each includes applying heat at a temperature ranging from about 80 degrees to about 140 degrees Celsius for a time period ranging from about 15 minutes and about 40 minutes.

15. The method of claim 13, further including treating the outer surface and an inner surface of the device housing opposite the outer surface with a passivation agent or an oxidization agent, prior to applying the primer formulation to form:
a first passivation or oxidization layer disposed on the outer surface of the substrate, such that the first passivation or oxidization layer is disposed between the primer layer and the outer surface of the substrate; and
a second passivation or oxidization layer disposed on the inner surface of the substrate.
